(19) United States
(12) Patent Application Publication
(10) Pub. No.: US 2009/0091673 A1
(43) Pub. Date: Apr. 9, 2009

(54) Display panel and dielectric apparatus with ESD protection effect

(76) Inventors: Shih-Han Chen, Taipei City (TW); Shan-Hung Tsai, Taichung City (TW)

Correspondence Address: LIU & LIU, 444 S. FLOWER STREET, SUITE 1750, LOS ANGELES, CA, 90071, US

(21) Appl. No.: 12/215,689

(22) Filed: Jun. 27, 2008

(30) Foreign Application Priority Data
Jun. 29, 2007 (TW) 096123737

(51) Int. Cl. G02F 1/133

(52) U.S. Cl. 349/40

(57) ABSTRACT

A display panel and an electric apparatus with ESD protection effect are disclosed. The display panel comprises a panel substrate and patterned conductive layers stacked over the panel substrate. The display panel also has an array display area and a driving area. A first conductive layer of the patterned conductive layers comprises substantially repetitive patterns inside the driving area. The first conductive layer also has a dummy bar formed beside an edge pattern of the substantially repetitive patterns.

### BACKGROUND OF THE INVENTION

1. Field of the Invention

The invention relates to an electrostatic discharge (ESD) protection structure, and more particularly to an electrostatic discharge (ESD) protection structure on a display panel.

2. Description of the Related Art

In recent years, multi-media systems have become more and more popular due to highly advanced development of semiconductors and display devices. Conventional display devices used for multi-media systems usually employ a cathode ray tube as a display unit. The display devices constructed with a cathode ray tube, however, is large and costly in light of volume and power consumption, respectively. Specifically, the display devices are not suitable for portable applications, which generally require a compact size and extended operating time without external power cords. Additionally, a cathode ray tube has a problem of radiation, which is not healthy for users' eyes. Therefore, various kinds of display panels have been developed and designed and are currently replacing cathode ray tubes. Among them, thin film transistor liquid crystal displays (TFT-LCD), with advantages such as a thinner shape, lower power consumption, higher image quality and less radiation.

Generally speaking, there are two main types of TFT-LCDs: amorphous TFT-LCDs and polysilicon TFT-LCDs. Polysilicon TFT-LCDs are fabricated using low temperature polysilicon (LTPS) technology. Amorphous TFT-LCDs are fabricated using amorphous silicon (a-silicon) technology. It is well known in the art that electron mobility of LTPS, up to 200 cm²/V-sec, is much higher than that of an a-silicon. Therefore, devices fabricated using LTPS technology can have a smaller device scale while maintaining the same driving ability. Accordingly, display panels fabricated using LTPS technology may also have larger aperture ratio and lower power consumption. LTPS technology also allow a portion of driving circuits in a periphery area and TFTs in an array display area to be formed on a display panel at the same time. As such, LCD panels formed using LTPS technology may have higher reliability and are commercially cheaper due to the relatively less required assembly steps. LTPS TFT-LCD panels may also have smaller volume due to requirement for relatively less area for mounting external driving integrate circuits. Therefore, LTPS TFT-LCD panels are much more suitable for portable electronic products.

LTPS technology, however, is complex as a portion of driving circuits is integrated on a panel substrate with a TFT array. To achieve integration, additional masks and processes are required to pattern additional materials deposited on the panel substrate. It is common that LTPS TFT-LCD panel fabrication has lower yield, compared with the a-silicon TFT-LCD panel fabrication. Therefore, yield improvement of LTPS TFT-LCD panels is one of the major issues in the LTPS industry.

ESD has always been a major product yield issue in manufacturing electronic devices due to reliability issues. There are several known test models, such as human body mode (HBM), machine mode (MM), and others, to simulate different conditions under which ESD occurs. HBM test model simulates ESD of an electronic device coming in contact with a static-electricity-charged human body having high impedance. MM test model simulates ESD of an electronic device coming in contact with a conductive machine having low impedance. Regulations require that electronic devices must meet the predetermined aforementioned test levels before any device can be made commercially available. A conventional ESD protection structure used in panels comprises guard rings and protection diodes, which basically release or dissipate electrostatic charge away from the area desired for protection through conductive lines. However, the conventional ESD protection structure doesn't work unless the guard rings and the protection diodes are electrically connected to the subsequent conductive lines in other layers to form a conductive network. If ESD occurs before formation of the conductive network, the panel with the guard rings and the protection diodes still risk possible ESD damage, thus, decreasing product yield.

FIG. 1 shows a layout of a conductive layer of a conventional LTPS-TFT display panel 100. As mentioned before, a portion of the driving circuits in a periphery area and the TFTs in the array display area are formed on the panel substrate (not shown) of the conventional LTPS-TFT panel at the same time during fabrication. Therefore, the LTPS-TFT display panel 100 comprises two areas of an array display area 102 and a driving circuit area 104. Several shift registers (for driving scanning lines) and digital-to-analog converters (for driving data lines) having the same structure may be formed in the driving circuit area 104. Therefore, numerous substantially repeated patterns, such as, pattern 108ₐ to 108ₑ and pattern 106, are formed in the driving area 104. The patterns 108ₐ to 108ₑ are the same as each other. Lines in each of the patterns 106 are substantially repeated with each other with little differences in lengths.

As stated earlier, ESD may occur before the formation of a conductive network. For example, ESD may occur due to non-uniform charges in a plasma chamber used in etching or deposing processes after a polysilicon layer and/or a gate metal layer is formed during the LTPS-TFT fabrication process. Therefore, a local electrostatic stress may occur on the LTPS-TFT display panel 100 as shown in FIG. 1. Once the local electrostatic stress is large enough to induce ESD, electrostatic charge may breakthrough an insulating dielectric layer to cause short-circuiting or burn out conductive line to cause an open-circuit. Therefore, a polysilicon pattern and/or a gate metal layer pattern, such as pattern 108ₐ to 108e and pattern 106 without ESD protection from a conductive network, may suffer ESD damage.

### BRIEF SUMMARY OF INVENTION

To solve the above described problems, a display panel with ESD protection effect is provided. An exemplary embodiment of the display panel comprises a panel substrate and patterned conductive layers stacked over the panel substrate. The display panel also has an array display area and a driving area. A first conductive layer of the patterned conductive layers comprises substantially repetitive patterns inside the driving area. The first conductive layer also has a dummy bar formed beside an edge pattern of the substantially repetitive patterns. When the display panel is properly powered, the dummy bar electrically floats in the display panel and is isolated from any power sources, such that the dummy bar is capable of protecting the edge pattern of the substantially repetitive patterns from ESD damage.

An electrical device is provided. An exemplary embodiment of the electrical device comprises an image capable integrated circuit used to provide an image signal. The electrical device also comprises a panel. A plurality of patterned conductive layers is stacked over the panel substrate, wherein the display panel comprises an array display area formed having display units arranging in an array. A driving area is formed having a driving circuit used to receive the image signal and drive the display units. A first conductive layer of the patterned conductive layers comprises substantially repetitive patterns inside the driving area and a dummy bar formed beside an edge pattern of the substantially repetitive patterns, wherein when the display panel is properly powered, the dummy bar electrically floats in the display panel and is isolated from any power sources, such that the dummy bar is capable of protecting the edge pattern of the substantially repetitive patterns from ESD damage.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a layout of a conductive layer of a conventional LTPS-TFT display panel.

FIG. 2 shows a layout of a conductive layer of an exemplary embodiment of an LTPS-TFT display panel according to the invention.

FIG. 3 shows a cross section of the LTPS-TFT display panel as shown in FIG. 2.

FIG. 4 shows dimensional symbols according to a dummy bar and an edge conductive line according to the invention.

FIG. 5 shows an electronic device having the LTPS-TFT display panel as shown in FIG. 2.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims. Wherever possible, the same reference numbers are used in the drawings and the descriptions to refer to the same or like parts.

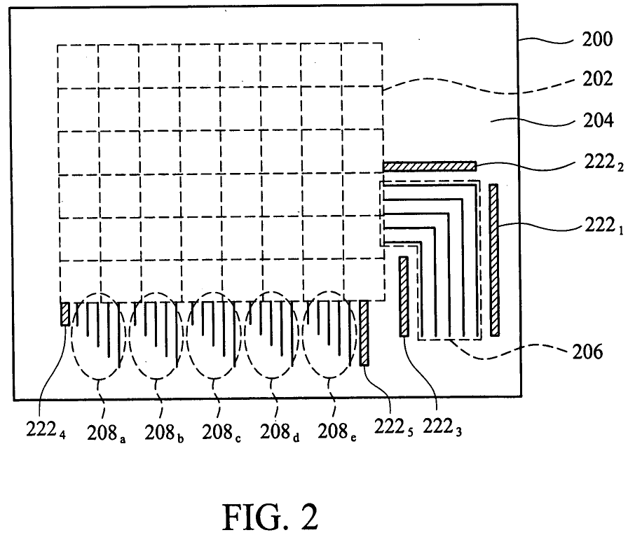

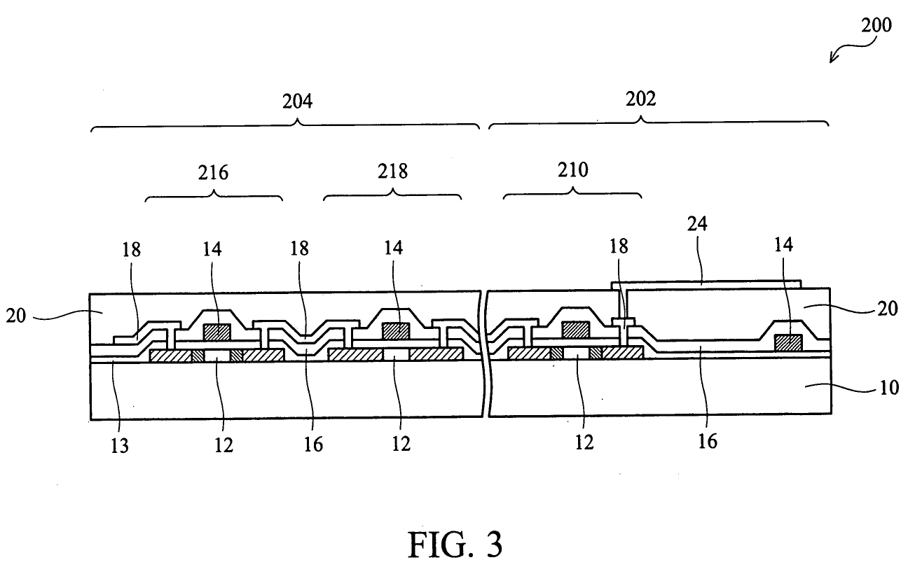

FIG. 2 shows a layout of a conductive layer of an exemplary embodiment of an LTPS-TFT display panel 200 according to the invention. FIG. 3 shows a cross section of the LTPS-TFT display panel 200 as shown in FIG. 2. It is noted that the LTPS-TFT display panel 200 is used as an exemplary embodiment of the invention, but not limited only to LTPS-TFT display panels.

As shown in FIG. 3, LTPS-TFT display panel 200 comprises a panel substrate 10, such as a transparent glass, formed with patterned conductive layers and dielectric layers stacked thereon. A patterned polysilicon layer 12 is used as channels and source/drain areas of metal-oxide-semiconductor (MOS) transistors. A gate dielectric layer 13 covers the patterned polysilicon layer 12, electrically isolating conductive gates from channel areas. A patterned gate metal layer 14 is mainly used as conductive gates of MOS transistors. The patterned gate metal layer 14 also provides one electrode for the capacitor of a display cell. After patterning the gate metal layer 14, electronic elements on the panel substrate 10 are substantially formed but the electrical connections between them are not. During this stage, the gate metal layer 14 and the polysilicon layer 12 are also isolated from each other. A dielectric layer 16 is then formed covering the gate metal layer 14. After patterning the dielectric layer 16, the removal of a portion of the dielectric layer 16 may expose a portion of the polysilicon layer 12 and the gate metal layer 14. A metal conductive layer 18 is deposited and patterned to define a desired local connection for the electrical elements on the panel substrate 10. A metal conductive layer 24 is deposited and patterned to form not only the desired connections for the electronic elements, but also an electrode of controlling the liquid crystal of a display unit.

As shown in FIG. 2, the LTPS-TFT display panel 200 has two areas, an array display area 202 and a driving area 204. The array display area 202 comprises several liquid crystal display units arranged in an array. In one embodiment, each crystal display unit has a cell select NMOS 210, a storage capacitor and a liquid crystal controlling electrode as shown in area 202 of FIG. 3. The driving area 204 comprises complementary MOS (CMOS) circuits formed therein. The CMOS circuits comprise a NMOS transistor 216 and a PMOS transistor 218 connected to each other.

In the driving area 204, several of same shift registers, same digital-to-analog converters and others are formed. Namely, numerous substantially repeated patterns, such as patterns 208ₐ to 208ₑ and pattern 206, are formed in the driving area 204 as shown in FIG. 2. The patterns 208ₐ to 208ₑ, which are composed of a plurality of straight lines respectively, have exactly the same dimensions with each other. Lines in each of the patterns 208 are also substantially repeated with each other with increasing lengths from one direction to another (from left to right). The patterns 206 are composed of a plurality of inverted-L shape lines as shown in FIG. 2. Lines in each of the patterns 206 are substantially repeated with each other with increasing lengths from one direction to another (from left to right).

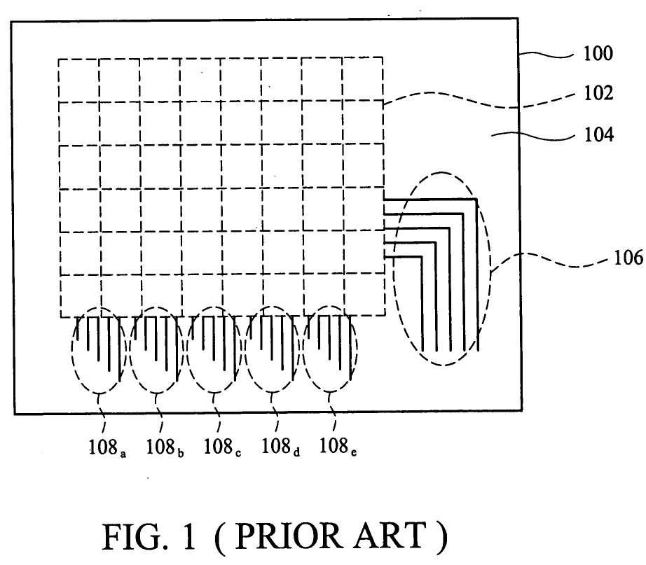

Compared with FIG. 1, FIG. 2 has additional numerous dummy bars 222₁ to 222₅. The dummy bars 222₁ to 222₃ are disposed outside the pattern 206 which has substantially repeated lines. For example, the dummy bar 222₁ is disposed on the right outside of a right edge line of the pattern 206. The dummy bar 222₂ is disposed on the top outside of a top edge line of the pattern 206. The dummy bar 222₃ is disposed on the left outside of a left edge line of the pattern 206. The dummy bars 222₄ and 222₅ are disposed on the outside of the patterns 208ₐ to 208ₑ which have substantially repeated lines. For example, the dummy bar 222₄ is disposed on the left outside of a left edge line of the pattern 208ₐ. The dummy bar 222₅ is disposed on the right outside of a right edge line of the pattern 208ₑ.

During the fabricating processes of the LTPS-TFT display panel substrate 100 as shown in FIG. 1, when the ESD problem usually occurs, the edge conductive lines of the substantially repeated patterns are damaged. The ESD damage frequently occurs during the processes preceding, forming of the metal conductive layer 18. One possible explanation is as follows. Before forming the metal conductive layer 18 as described above, all the electronic elements on the LTPS-TFT display panel substrate 100 are not electrical connected to each other. Therefore, no guard rings or protection diodes can be used to provide ESD protection. The LTPS-TFT display panel substrate 100 without ESD protection may experience electrostatic stress introduced by non-uniform plasma, and easily suffer damage due to electrostatic discharge (ESD). For the LTPS-TFT display panel substrate 100, the region having the most possibility of ESD stress is the region having the maximum electric field (due to the earliest breakdown time). For the substantially repeated patterns, electric fields on the edge conductive line of the conductive patterns are usually larger than that on the inner conductive lines of the conductive patterns. Therefore, it is expected that ESD damage tends to occur on the edge conductive line of the conductive patterns.

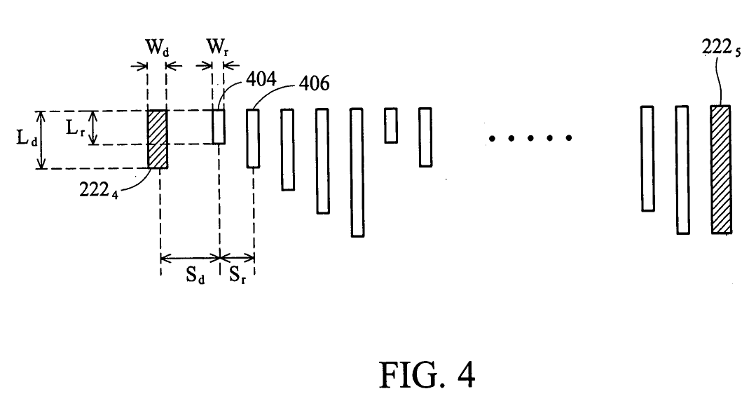

As shown on FIG. 2, the dummy bars 222₁ to 222₅ may protect the edge pattern from ESD damage. The dummy bars may have at least two functions. One is that the dummy bars make the edge conductive lines of the conductive patterns “non-edge” conductive lines. The other is that the dummy bars make the ESD damage occur on the dummy bars but not on the edge conductive lines of the conductive patterns. In other words, the dummy bars can be used to simulate or substitute the edge conductive lines of the conductive patterns. Therefore, the dummy bars may have dimensional limitations to achieve a goal of simulation or substitution. FIG. 4 illustrates dimensional symbols for the dummy bar 222₄ and the pattern 208ₐ according to the invention. The pattern 208ₐ has a left edge conductive line 404. The left edge conductive line 404 has a width W_{f}, a length Lᵣ and a spacing Sᵣ to an adjacent inner conductive line 406. Similarly, the dummy bar 222₄ is located left to the left edge conductive line 404. The dummy bar 222₄ has a width W_{d}, a length L_{d} and a spacing S_{d} to the left edge conductive line 404. In one embodiment, the width W_{d} of the dummy bar 222₄ is larger than the width Wᵣ of the edge conductive line, and the length L_{d} of the dummy bar 222₄ is larger than the length Lᵣ of the edge conductive line. A ratio of S_{d}/Sᵣ may have a range of about 50% to 150%. A ratio of W_{d}/Wᵣ may have a range of about 100% to 200%. And a ratio of L_{d}/Lᵣ may have a range of about 100% to 200%.

Because the dummy bars 222₁ to 222₅ play a sacrificial role by attracting ESD, the dummy bars 222₁ to 222₅ may suffer ESD damage in the LTPS-TFT display panel 200. In one embodiment, the dummy bars 222₁ to 222₅ are designed as being able to electrically float when the LTPS-TFT display panel 200 is properly powered, and the dummy bars 222₁ to 222₅ are isolated from any power sources by isolation features or materials. ESD damage generally results in short circuiting or an open circuit. If the dummy bars 222₁ to 222₅ are not designed as being able to electrically float, the resulting short circuiting or open circuit may lead to mis-operation of the LTPS-TFT display panel 200. The dummy bars 222₁ to 222₅ are designed as being able to electrically float so that mis-operation of the LTPS-TFT display panel 200 can be avoided, even if the dummy bars are short circuited with a signal line or a power line.

One way of electrically floating the dummy bars 222₁ to 222₅ is not to connect the dummy bars 222₁ to 222₅ to other conductive layers. For example, if the dummy bars 222₁ to 222₅ are all formed by the polysilicon layer 12 as shown in FIG. 3, then the dummy bars 222₁ to 222₅ can be covered by the gate dielectric layer 13 and the dielectric layer 16 thus, not electrically connecting to the metal conductive layer 18. If the dummy bars 222₁ to 222₅ are all formed by the gate metal layer 14, then the dummy bars 222₁ to 222₅ can be covered by the dielectric layer 16 and not electrically connected to the metal conductive layer 18. Meanwhile, the dummy bars may also use another conductive layer beside the polysilicon layer 12 and the gate metal layer 14. Dummy bars provide a further ESD protection effect, in addition to the guard rings and the protection diodes.

Another way of electrically floating the dummy bars 222₁ to 222₅ is to connect the dummy bars 222₁ to 222₅ to other metal layers, but not to any power lines or signal lines disposed on the display panel.

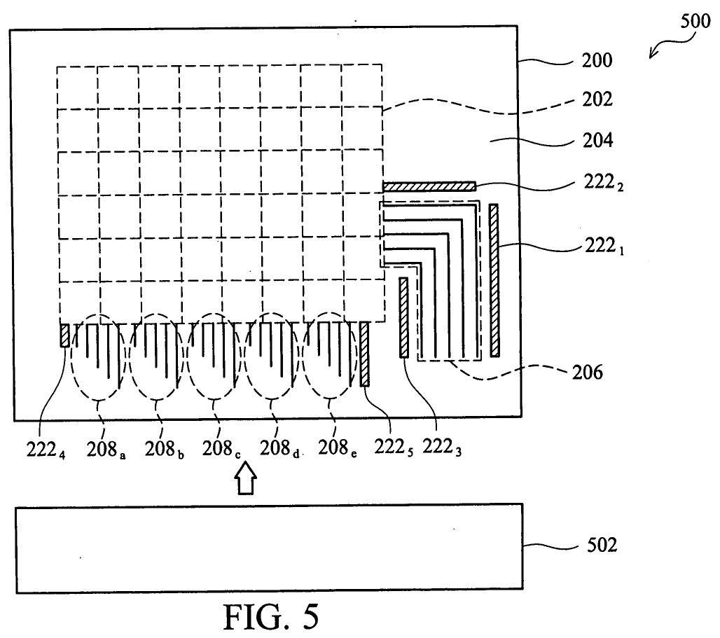

FIG. 5 shows an electronic device 500 having the LTPS-TFT display panel 200 as shown in FIG. 2. The electronic device 500 may be a digital camera, a cell phone, a notebook computer, a liquid crystal display television, a digital versatile disc (DVD), a car display, a personal digital assistant (PDA), a display monitor or a tablet computer. The LTPS-TFT display panel 200 is used to show image signals transported by an image capable integrated circuit 502. As mentioned previously, the LTPS-TFT display panel 200 may comprise the driving circuits formed in the driving area 204. The driving circuits are used to receive image signals, and then drive liquid crystal display units of the array display area 202 according to the received image signals. The LTPS-TFT display panel 200 also comprises the dummy bars 222₁ to 222₅ formed thereon. The dummy bars 222₁ to 222₅ are used to protect the edge conductive line of the substantially repetitive patterns.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display panel with ESD protection effect, comprising:
a panel substrate; and
a plurality of patterned conductive layers stacked over the panel substrate, wherein the display panel comprises an array display area and a driving area, and a first conductive layer of the patterned conductive layers comprises substantially repetitive patterns inside the driving area and a dummy bar formed beside an edge pattern of the substantially repetitive patterns, wherein when the display panel is properly powered, the dummy bar electrically floats in the display panel and is isolated from any power sources, such that the dummy bar is capable of protecting the edge pattern of the substantially repetitive patterns from ESD damage.

2. The display panel as claimed in claim 1, wherein the dummy bar is isolated with the patterned conductive layers except for the first conductive layer.

3. The display panel as claimed in claim 1, wherein the edge pattern has a plurality of conductive lines and at least one spacing, and a distance between the dummy bar and an edge conductive line of the conductive lines is between 50% to 150% of the spacing.

4. The display panel as claimed in claim 1, wherein the edge pattern has a plurality of conductive lines, and a width of the dummy bar is larger than that of the edge conductive line.

5. The display panel as claimed in claim 4, wherein the width of the dummy bar is 100% to 200% large than that of the edge conductive lines

6. The display panel as claimed in claim 1, wherein the edge pattern has a plurality of conductive lines, and a length of the dummy bar is larger than that of the edge conductive line.

7. The display panel as claimed in claim 6, wherein the length of the dummy bar is 100% to 200% larger than that of the edge conductive line.

8. The display panel as claimed in claim 1, wherein the first conductive layer is a polysilicon layer.

9. The display panel as claimed in claim 1, wherein the first conductive layer is a gate metal layer.

10. An electrical device, comprising:
an image capable integrated circuit used to provide an image signal;
a panel; and
a plurality of patterned conductive layers stacked over the panel substrate, wherein the display panel comprises an array display area formed having display units arranged in an array, and a driving area formed having a driving circuit used to retrieve the image signal and drive the display units, and a first conductive layer of the patterned conductive layers comprises substantially repetitive patterns inside the driving area and a dummy bar formed beside an edge pattern of the substantially repetitive patterns, wherein when the display panel is properly powered, the dummy bar electrically floats in the display panel and is isolated from any power sources, such that the dummy bar is capable of protecting the edge pattern of the substantially repetitive patterns from ESD damage.

11. The electrical device as claimed in claim 10, wherein the dummy bar is isolated with the patterned conductive layers except for the first conductive layer.

12. The electrical device as claimed in claim 10, wherein the edge pattern has a plurality of conductive lines and at least one spacing, and a distance between the dummy bar and an edge conductive line of the conductive lines is between 50% to 150% of the spacing.

13. The electrical device as claimed in claim 10, wherein the edge pattern has a plurality of conductive lines, and a width of the dummy bar is larger than that of the edge conductive line.

14. The electrical device as claimed in claim 13, wherein the width of the dummy bar is 100% to 200% larger than that of the edge conductive line.

15. The electrical device as claimed in claim 10, wherein the edge pattern has a plurality of conductive lines, and a length of the dummy bar is larger than that of the edge conductive lines.

16. The electrical device as claimed in claim 15, wherein the length of the dummy bar is 100% to 200% larger than that of the edge conductive line.

17. The electrical device as claimed in claim 10, wherein the array display area is a liquid crystal unit array area.

18. The electrical device as claimed in claim 10, wherein the first conductive layer is a polysilicon layer.

19. The electrical device as claimed in claim 10, wherein the first conductive layer is a gate metal layer.

20. The electrical device as claimed in claim 10 comprises a digital camera, a cell phone, a notebook computer, a liquid crystal display television, a digital versatile disc (DVD), a car display, a personal digital assistant (PDA), a display monitor or a tablet computer.
